(19) United States
(12) Patent Application Publication
(10) Pub. No.: US 2014/0024357 A1
(43) Pub. Date: Jan. 23, 2014

(54) METHOD AND APPARATUS FOR CELL TYPE SPECIFIC MEASUREMENT CONFIGURATION

(71) Applicants: Jussi-Pekka Koskinen, Oulu (FI); Lars Dalsgaard, Oulu (FI); Ilkka Keskitalo, Oulu (FI); Jarkko Koskela, Oulu (FI)

(72) Inventors: Jussi-Pekka Koskinen, Oulu (FI); Lars Dalsgaard, Oulu (FI); Ilkka Keskitalo, Oulu (FI); Jarkko Koskela, Oulu (FI)

(73) Assignee: Nokia Corporation, Espoo (FI)

(21) Appl. No.: 14/009,245

(22) PCT Filed: Apr. 11, 2011
(86) PCT No.: PCT/IB11/51550

§ 371 Date: Oct. 1, 2013

(51) Int. Cl. H04W 24/10

(52) U.S. Cl. CPC H04W 24/10
USPC 455/418

(57) ABSTRACT

Various methods for providing cell type specific measurement configuration are provided. One example method may include receiving configuration data comprising an indication of one or more events configured to trigger a report. The configuration data may comprise an indication of one or more cells associated with the one or more events. The method of this example embodiment may further include providing for transmission of a report, wherein the report is provided for transmission in response to an occurrence of at least one of the one or more events associated with at least one of the one or more cells. Similar and related example methods, example apparatuses, and example computer program products are also provided.

### TECHNICAL FIELD

Embodiments of the present invention relate generally to communication technology, and, more particularly, relate to a method, apparatus, and computer program product for providing cell type specific measurement configuration.

### BACKGROUND

The modern communications era has brought about a tremendous expansion of wireline and wireless networks. Computer networks, television networks, and telephony networks are experiencing an unprecedented technological expansion, fueled by consumer demand. Wireless and mobile networking technologies have addressed related consumer demands, while providing more flexibility and immediacy of information transfer.

Current and future networking technologies continue to facilitate ease of information transfer and convenience to users. In order to provide easier or faster information transfer and convenience, telecommunication industry service providers are developing improvements to existing networks. In this regard, for example, improvements are being made to the universal mobile telecommunications system (UMTS) terrestrial radio access network (UTRAN). Further, for example, the evolved-UTRAN (E-UTRAN) is currently being developed. The E-UTRAN, which is also known as Long Term Evolution (LTE), is aimed at upgrading prior technologies by improving efficiency, lowering costs, improving services, making use of new spectrum opportunities, and providing better integration with other open standards.

One development in networks is the provision for localized base stations that may serve a smaller area than a typical macrocell, for example picocells, or that may be individually owned and deployed in homes and businesses, for example femtocells. Access to a picocell may be provided through the same network operator as one or more macrocells, while access to a network through a femtocell may be provided by a network operator, such as a public land mobile network (PLMN) operator. A picocell may comprise a NodeB (NB) in UTRAN and/or an evolved NodeB (eNB) in E-UTRAN, while a femtocell may comprise a NodeB referred to as Home NodeB (HNB) in UTRAN and/or as a Home evolved NodeB (HeNB) in E-UTRAN. The various localized base stations may overlap with macrocell base stations and with one another. As a result, a user device may be able to select from the base stations within range when deciding how to connect to the network.

Accordingly, it may be desirable to provide systems, methods, apparatuses, and computer program products for providing cell type specific measurement configuration.

### SUMMARY

In a network operating under the Long Term Evolution (LTE) standard, the network may include a combination of various types of base station cells, for example macrocells, microcells, picocells, femtocells, home cells, and the like. The network operator may wish to provide cell specific measurement configuration information to the terminal apparatuses operating on the network. For example, the network operator may wish to configure the terminal apparatuses to send measurement reports based on the detection of certain events related to a subset of the cells operating in the network (e.g. a particular type of cell such as femtocells) rather than all operating cells. The network operator may further desire to configure terminal apparatuses such that the thresholds and offsets used to detect the events vary from one group of cells to the next. A need, therefore, exists to allow a network operator to provide measurement event configuration information to terminal apparatuses that applies to a specific subset of cells operating on the network. Various embodiments of the invention described below seek to offer solutions to the problem by providing apparatuses and methods for providing cell type specific measurement configuration.

Methods, apparatuses, and computer program products are herein provided for providing cell type specific measurement configuration. Systems, methods, apparatuses, and computer program products in accordance with various embodiments may provide several advantages to computing devices, computing device users, and network providers. Some example embodiments advantageously enable a network operator to include a list of one or more cells in measurement event configuration data to identify those cells to which the configuration data applies. In this regard, a network operator may provide different configuration information for different groups of cells. For example, the network operator may provide different configuration data for each type of cell (e.g. macrocell, microcell, picocell, femtocell, home cell, or the like). In accordance with some example embodiments, a network operator may configure a terminal apparatus such that the terminal apparatus sends measurement reports based on cell specific events. In this regard, a network operator may limit the number of measurement reports a terminal apparatus sends by restricting measurement reports for certain events based on the cell that triggers the event.

According to example embodiments, each instance of measurement event configuration information may define different thresholds and/or offsets for a particular event based on the cells associated with the instance of measurement event configuration data. In this regard, the measurement event configuration information for smaller cells (e.g. picocells and femtocells) may define lower thresholds and/or offsets in order to trigger a particular event. A terminal apparatus may, for example, send a measurement report for a smaller cell sooner from the point of initial detection of the cell than for a larger cell (e.g. a macrocell), effectively extending the range of the smaller cells. In some embodiments, a network operator may therefore be configured to initiate mobility procedures (e.g. handoff) sooner with respect to smaller cells. As a result, network traffic for the terminal apparatus may be offloaded to smaller cells sooner, thereby reducing the burden on the larger cell layer. These example embodiments may advantageously improve mobility performance between cell layers, increase the speed of offloading to smaller cells, and improve network capacity.

Furthermore, in various embodiments of the present invention, a terminal apparatus may reduce power consumption by maximizing usage of smaller cells, which require less transmission power by the terminal apparatus. The lower transmission power may further result in decreased co-channel interference resulting from smaller cells overlapping with larger cells. In many instances, the use of smaller cells, such as femtocells or home cells, may also be less expensive to the user of a terminal apparatus.

In an example embodiment, a method is provided, which may comprise receiving configuration data comprising an indication of one or more events configured to trigger a report. The configuration data may comprise an indication of one or more cells associated with the one or more events. The method of this example embodiment may further comprise providing for transmission of a report. The report may be provided for transmission in response to an occurrence of at least one of the one or more events associated with at least one of the one or more cells. In another embodiment, a computer program may be provided for executing the various operations of the example method.

In another example embodiment, an apparatus comprising at least one processor and at least one memory storing computer program code is provided. The at least one memory and stored computer program code may be configured, with the at least one processor, to cause the apparatus of this example embodiment to at least receive configuration data comprising an indication of one or more events configured to trigger a report. The configuration data may comprise an indication of one or more cells associated with the one or more events. The at least one memory and stored computer program code may be configured, with the at least one processor, to further cause the apparatus of this example embodiment to provide for transmission of a report. The report may be provided for transmission in response to an occurrence of at least one of the one or more events associated with at least one of the one or more cells.

In another example embodiment, a computer program product is provided. The computer program product of this example embodiment may comprise at least one computer-readable storage medium having computer-readable program instructions stored therein. The program instructions of this example embodiment may comprise program instructions configured to receive configuration data comprising an indication of one or more events configured to trigger a report. The configuration data may comprise an indication of one or more cells associated with the one or more events. The program instructions of this example embodiment may further comprise program instructions configured to provide for transmission of a report. The report may be provided for transmission in response to an occurrence of at least one of the one or more events associated with at least one of the one or more cells.

In another example embodiment, an apparatus is provided, which may comprise means for receiving configuration data comprising an indication of one or more events configured to trigger a report. The configuration data may comprise an indication of one or more cells associated with the one or more events. The apparatus of this example embodiment may further comprise means for providing for transmission of a report. The report may be provided for transmission in response to an occurrence of at least one of the one or more events associated with at least one of the one or more cells.

In an example embodiment, a method is provided, which may comprise providing for transmission of configuration data comprising an indication of one or more events configured to trigger a report. The configuration data may comprise an indication of one or more cells associated with the one or more events. The method of this example embodiment may further comprise receiving a measurement report. Furthermore, the method of this example embodiment may comprise using the information in the measurement report to determine whether to initiate mobility procedures. In another embodiment, a computer program may be provided for executing the various operations of the example method.

In an example embodiment, an apparatus comprising at least one processor and at least one memory storing computer program code is provided. The at least one memory and stored computer program code may be configured, with the at least one processor, to cause the apparatus of this example embodiment to at least provide for transmission of configuration data comprising an indication of one or more events configured to trigger a report. The configuration data may comprise an indication of one or more cells associated with the one or more events. The at least one memory and stored computer program code may be configured, with the at least one processor, to further cause the apparatus of this example embodiment to receive a measurement report. The at least one memory and stored computer program code may be configured, with the at least one processor, to further cause the apparatus of this example embodiment to use the information in the measurement report to determine whether to initiate mobility procedures.

In another example embodiment, a computer program product is provided. The computer program product of this example embodiment may comprise at least one computer-readable storage medium having computer-readable program instructions stored therein. The program instructions of this example embodiment may comprise program instructions configured to provide for transmission of configuration data comprising an indication of one or more events configured to trigger a report. The configuration data may comprise an indication of one or more cells associated with the one or more events. The program instructions of this example embodiment may further comprise program instructions configured to receive a measurement report. Furthermore, the program instructions of this example embodiment may comprise program instructions configured to use the information in the measurement report to determine whether to initiate mobility procedures.

The above summary is provided merely for purposes of summarizing some example embodiments of the invention so as to provide a basic understanding of some aspects of the invention. Accordingly, it will be appreciated that the above described example embodiments are merely examples and should not be construed to narrow the scope or spirit of the invention in any way. It will be appreciated that the scope of the invention encompasses many potential embodiments, some of which will be further described below, in addition to those here summarized.

### BRIEF DESCRIPTION OF THE DRAWING(S)

Having thus described some example embodiments of the invention in general terms, reference will now be made to the accompanying drawings, which are not necessarily drawn to scale, and wherein:

FIG. 1 illustrates a system for providing cell type specific measurement configuration according to some example embodiments of the present invention;

FIG. 2 illustrates a schematic block diagram of a mobile terminal according to some example embodiments of the present invention;

FIG. 3 illustrates a block diagram of a terminal apparatus according to some example embodiments of the present invention.

FIG. 4 illustrates a block diagram of a serving network apparatus according to some example embodiments of the present invention.

FIG. 5 illustrates a flowchart according to an example method for providing cell type specific measurement configuration according to some example embodiments of the present invention; and

FIG. 6 illustrates a flowchart according to an example method for providing cell type specific measurement configuration according to some example embodiments of the present invention.

### DETAILED DESCRIPTION

Example embodiments of the present invention will now be described more fully hereinafter with reference to the accompanying drawings, in which some, but not all embodiments of the invention are shown. Indeed, the invention may be embodied in many different forms and should not be construed as limited to the embodiments set forth herein; rather, these embodiments are provided so that this disclosure will satisfy applicable legal requirements. Like reference numerals refer to like elements throughout. The terms “data,” “content,” “information,” and similar terms may be used interchangeably, according to some example embodiments of the present invention, to refer to data capable of being transmitted, received, operated on, and/or stored.

The term “computer-readable medium” as used herein refers to any medium configured to participate in providing information to a processor, including instructions for execution. Such a medium may take many forms, including, but not limited to a non-transitory computer-readable storage medium (for example, non-volatile media, volatile media), and transmission media. Transmission media include, for example, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Examples of computer-readable media include a floppy disk, a flexible disk, hard disk, magnetic tape, any other magnetic medium, a compact disc read only memory (CD-ROM), compact disc compact disc-rewritable (CD-RW), digital versatile disc (DVD), Blu-Ray, any other optical medium, punch cards, paper tape, optical mark sheets, any other physical medium with patterns of holes or other optically recognizable indicia, a random access memory (RAM), a programmable read only memory (PROM), an erasable programmable read only memory (EPROM), a FLASH-EPROM, any other memory chip or cartridge, a carrier wave, or any other medium from which a computer can read. The term computer-readable storage medium is used herein to refer to any computer-readable medium except transmission media. However, it will be appreciated that where embodiments are described to use a computer-readable storage medium, other types of computer-readable mediums may be substituted for or used in addition to the computer-readable storage medium in alternative embodiments.

As used herein, the term ‘circuitry’ refers to all of the following: (a) hardware-only circuit implementations (such as implementations in only analog and/or digital circuitry); (b) to combinations of circuits and software (and/or firmware), such as (as applicable): (i) to a combination of processor(s) or (ii) to portions of processor(s)/software (including digital signal processor(s)), software, and memory(ies) that work together to cause an apparatus, such as a mobile phone or server, to perform various functions); and (c) to circuits, such as a microprocessor(s) or a portion of a microprocessor(s), that require software or firmware for operation, even if the software or firmware is not physically present.

This definition of ‘circuitry’ applies to all uses of this term in this application, including in any claims. As a further example, as used in this application, the term “circuitry” would also cover an implementation of merely a processor (or multiple processors) or portion of a processor and its (or their) accompanying software and/or firmware. The term “circuitry” would also cover, for example and if applicable to the particular claim element, a baseband integrated circuit or applications processor integrated circuit for a mobile phone or a similar integrated circuit in a server, a cellular network device, or other network device.

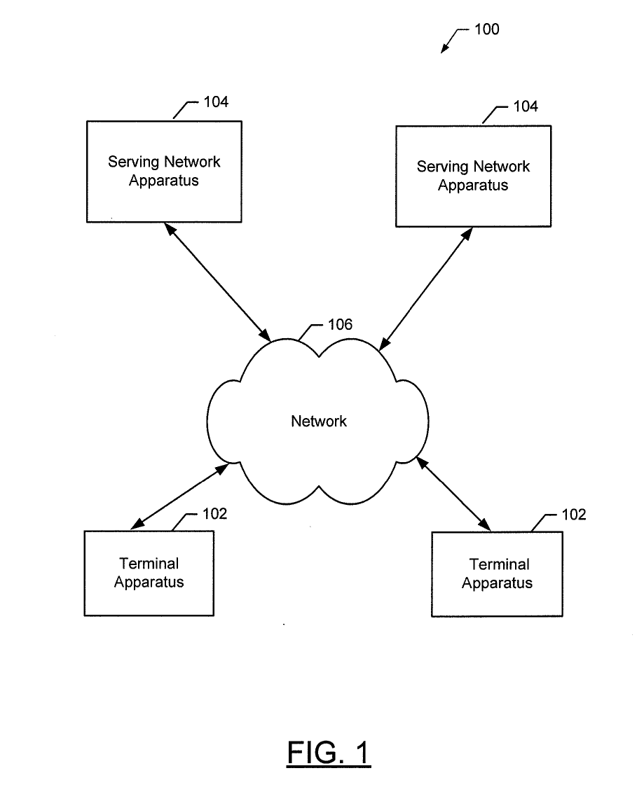

Referring now to FIG. 1, FIG. 1 illustrates a block diagram of a system 100 for providing cell type specific measurement configuration according to an example embodiment. It will be appreciated that the system 100 as well as the illustrations in other figures are each provided as an example of one embodiment and should not be construed to narrow the scope or spirit of the disclosure in any way. In this regard, the scope of the disclosure encompasses many potential embodiments in addition to those illustrated and described herein. As such, while FIG. 1 illustrates one example of a configuration of a system for providing cell type specific measurement configuration, numerous other configurations may also be used to implement embodiments of the present invention.

The system 100 may include a plurality of terminal apparatuses 102 and a plurality of serving network apparatuses 104. The system 100 may further comprise a network 106. The network 106 may comprise one or more wireline networks, one or more wireless networks, or some combination thereof. The network 106 may, for example, comprise a serving network (e.g., a serving cellular network) for one or more terminal apparatuses 102. The network 106 may comprise, in certain embodiments, one or more of the terminal apparatuses 102 and serving network apparatuses 104 themselves, In some embodiments, the network 106 comprises a public land mobile network (for example, a cellular network), such as may be implemented by a network operator (for example, a cellular access provider). The network 106 may operate in accordance with universal terrestrial radio access network (UTRAN) standards, evolved UTRAN (E-UTRAN) standards, current and future implementations of Third Generation Partnership Project (3GPP) LTE (also referred to as LTE-A) standards, current and future implementations of International Telecommunications Union (ITU) International Mobile Telecommunications—Advanced (IMT-A) systems standards, and/or the like. It will be appreciated, however, that where references herein are made to a network standard and/or terminology particular to a network standard, the references are provided merely by way of example and not by way of limitation.

According to various embodiments, one or more terminal apparatuses 102 may be configured to connect directly with one or more serving network apparatuses 104 via, for example, an air interface without routing communications via one or more elements of the network 106. Alternatively, one or more of the terminal apparatuses 102 may be configured to communicate with one or more of the serving network apparatuses 104 over the network 106. In this regard, the serving network apparatuses 104 may comprise one or more nodes of the network 106. For example, in some example embodiments, the serving network apparatuses 104 may be at least partially embodied on one or more computing devices that comprise an element of a radio access network (RAN) portion of the network 106. In this regard, the serving network apparatuses 104 may, for example, be at least partially embodied on an access point of the network 106 (for example, a macrocell, microcell, picocell, femtocell, closed subscriber group (CSG) cell, base station, base transceiver station (BTS), node B, evolved node B, and/or the like), which may, for example be configured to provide access to the network 106 (e.g., via a radio uplink) to one or more of the terminal apparatuses 102. Accordingly, each of the serving network apparatuses 104 may comprise a network node or a plurality of network nodes collectively configured to perform one or more operations attributed to the serving network apparatus 104 as described with respect to various example embodiments disclosed herein.

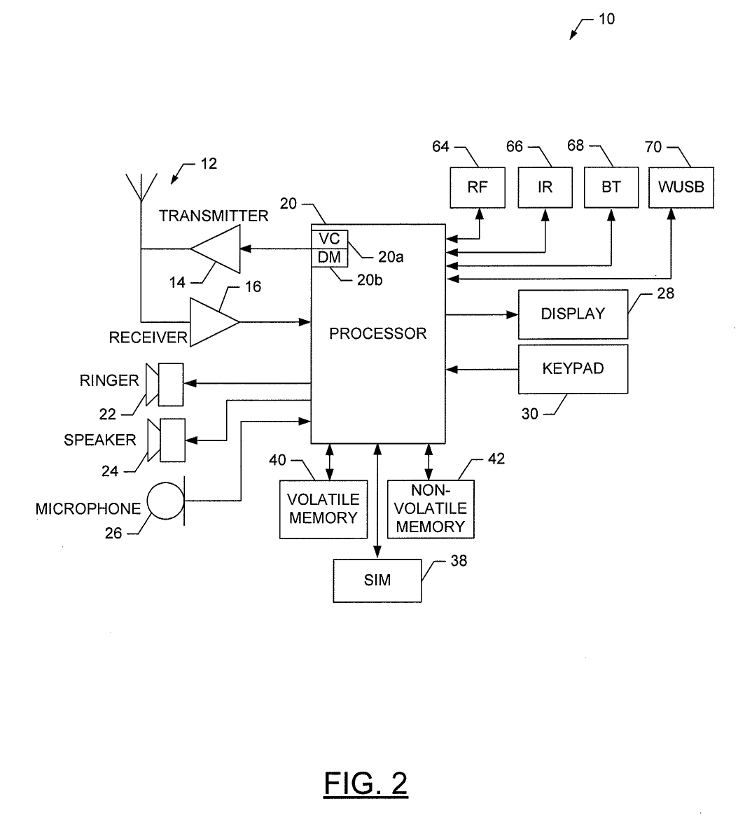

A terminal apparatus 102 may be embodied as any computing device, such as, for example, a desktop computer, laptop computer, mobile terminal, mobile computer, mobile phone, mobile communication device, game device, digital camera/camcorder, audio/video player, television device, radio receiver, digital video recorder, positioning device, wrist watch, portable digital assistant (PDA), any combination thereof, and/or the like. In an example embodiment, a terminal apparatus 102 may be embodied as a mobile terminal, such as that illustrated in FIG. 2.

In this regard, FIG. 2 illustrates a block diagram of a mobile terminal 10 representative of one embodiment of a terminal apparatus 102. It should be understood, however, that the mobile terminal 10 illustrated and hereinafter described is merely illustrative of one type of terminal apparatus 102 that may implement and/or benefit from various embodiments and, therefore, should not be taken to limit the scope of the disclosure. While several embodiments of the electronic device are illustrated and will be hereinafter described for purposes of example, other types of electronic devices, such as mobile telephones, mobile computers, portable digital assistants (PDAs), pagers, laptop computers, desktop computers, gaming devices, televisions, and other types of electronic systems, may employ various embodiments of the invention.

As shown, the mobile terminal 10 may include an antenna 12 (or multiple antennas 12) in communication with a transmitter 14 and a receiver 16. The mobile terminal 10 may also include a processor 20 configured to provide signals to and receive signals from the transmitter and receiver, respectively. The processor 20 may, for example, be embodied as various means including circuitry, one or more microprocessors with accompanying digital signal processor(s), one or more processor(s) without an accompanying digital signal processor, one or more coprocessors, one or more multi-core processors, one or more controllers, processing circuitry, one or more computers, various other processing elements including integrated circuits such as, for example, an ASIC (application specific integrated circuit) or FPGA (field programmable gate array), or some combination thereof. Accordingly, although illustrated in FIG. 2 as a single processor, in some embodiments the processor 20 comprises a plurality of processors. These signals sent and received by the processor 20 may include signaling information in accordance with an air interface standard of an applicable cellular system, and/or any number of different wireline or wireless networking techniques, comprising but not limited to Wi-Fi, wireless local access network (WLAN) techniques such as Institute of Electrical and Electronics Engineers (IEEE) 802.11, 802.16, and/or the like. In addition, these signals may include speech data, user generated data, user requested data, and/or the like. In this regard, the mobile terminal may be capable of operating with one or more air interface standards, communication protocols, modulation types, access types, and/or the like. More particularly, the mobile terminal may be capable of operating in accordance with various first generation (1G), second generation (2G), 2.5G, third-generation (3G) communication protocols, fourth-generation (4G) communication protocols, Internet Protocol Multimedia Subsystem (IMS) communication protocols (for example, session initiation protocol (SIP)), and/or the like. For example, the mobile terminal may be capable of operating in accordance with 2G wireless communication protocols IS-136 (Time Division Multiple Access (TDMA)), Global System for Mobile communications (GSM), IS-95 (Code Division Multiple Access (CDMA)), and/or the like. Also, for example, the mobile terminal may be capable of operating in accordance with 2.5G wireless communication protocols General Packet Radio Service (GPRS), Enhanced Data GSM Environment (EDGE), and/or the like. Further, for example, the mobile terminal may be capable of operating in accordance with 3G wireless communication protocols such as Universal Mobile Telecommunications System (UMTS), Code Division Multiple Access 2000 (CDMA2000), Wideband Code Division Multiple Access (WCDMA), Time Division-Synchronous Code Division Multiple Access (TD-SCDMA), and/or the like. The mobile terminal may be additionally capable of operating in accordance with 3.9G wireless communication protocols such as Long Term Evolution (LTE) or Evolved Universal Terrestrial Radio Access Network (E-UTRAN) and/or the like. Additionally, for example, the mobile terminal may be capable of operating in accordance with fourth-generation (4G) wireless communication protocols such as LTE Advanced and/or the like as well as similar wireless communication protocols that may be developed in the future.

Some Narrow-band Advanced Mobile Phone System (NAMPS), as well as Total Access Communication System (TACS), mobile terminals may also benefit from embodiments of this invention, as should dual or higher mode phones (for example, digital/analog or TDMA/CDMA/analog phones). Additionally, the mobile terminal 10 may be capable of operating according to Wi-Fi or Worldwide Interoperability for Microwave Access (WiMAX) protocols.

It is understood that the processor 20 may comprise circuitry for implementing audio/video and logic functions of the mobile terminal 10. For example, the processor 20 may comprise a digital signal processor device, a microprocessor device, an analog-to-digital converter, a digital-to-analog converter, and/or the like. Control and signal processing functions of the mobile terminal may be allocated between these devices according to their respective capabilities. The processor may additionally comprise an internal voice coder (VC) 20a, an internal data modem (DM) 20b, and/or the like. Further, the processor may comprise functionality to operate one or more software programs, which may be stored in memory. For example, the processor 20 may be capable of operating a connectivity program, such as a web browser. The connectivity program may allow the mobile terminal 10 to transmit and receive web content, such as location-based content, according to a protocol, such as Wireless Application Protocol (WAP), hypertext transfer protocol (HTTP), and/or the like. The mobile terminal 10 may be capable of using a Transmission Control Protocol/Internet Protocol (TCP/IP) to transmit and receive web content across the internet or other networks.

The mobile terminal 10 may also comprise a user interface including, for example, an earphone or speaker 24, a ringer 22, a microphone 26, a display 28, a user input interface, and/or the like, which may be operationally coupled to the processor 20. In this regard, the processor 20 may comprise user interface circuitry configured to control at least some functions of one or more elements of the user interface, such as, for example, the speaker 24, the ringer 22, the microphone 26, the display 28, and/or the like. The processor 20 and/or user interface circuitry comprising the processor 20 may be configured to control one or more functions of one or more elements of the user interface through computer program instructions (for example, software and/or firmware) stored on a memory accessible to the processor 20 (for example, volatile memory 40, non-volatile memory 42, and/or the like). Although not shown, the mobile terminal may comprise a battery for powering various circuits related to the mobile terminal, for example, a circuit to provide mechanical vibration as a detectable output. The user input interface may comprise devices allowing the mobile terminal to receive data, such as a keypad 30, a touch display (not shown), a joystick (not shown), and/or other input device. In embodiments including a keypad, the keypad may comprise numeric (0-9) and related keys (#, *), and/or other keys for operating the mobile terminal.

As shown in FIG. 2, the mobile terminal 10 may also include one or more means for sharing and/or obtaining data. For example, the mobile terminal may comprise a short-range radio frequency (RF) transceiver and/or interrogator 64 so data may be shared with and/or obtained from electronic devices in accordance with RF techniques. The mobile terminal may comprise other short-range transceivers, such as, for example, an infrared (IR) transceiver 66, a Bluetooth™ (BT) transceiver 68 operating using Bluetooth™ brand wireless technology developed by the Bluetooth™ Special Interest Group, a wireless universal serial bus (USB) transceiver 70 and/or the like. The Bluetooth™ transceiver 68 may be capable of operating according to ultra-low power Bluetooth™ technology (for example, Wibree™) radio standards. In this regard, the mobile terminal 10 and, in particular, the short-range transceiver may be capable of transmitting data to and/or receiving data from electronic devices within a proximity of the mobile terminal, such as within 10 meters, for example. Although not shown, the mobile terminal may be capable of transmitting and/or receiving data from electronic devices according to various wireless networking techniques, including Wi-Fi, WLAN techniques such as IEEE 802.11 techniques, IEEE 802.15 techniques, IEEE 802.16 techniques, and/or the like.

The mobile terminal 10 may comprise memory, such as a subscriber identity module (SIM) 38, a removable user identity module (R-UIM), and/or the like, which may store information elements related to a mobile subscriber. In addition to the SIM, the mobile terminal may comprise other removable and/or fixed memory. The mobile terminal 10 may include volatile memory 40 and/or non-volatile memory 42. For example, volatile memory 40 may include Random Access Memory (RAM) including dynamic and/or static RAM, on-chip or off-chip cache memory, and/or the like. Non-volatile memory 42, which may be embedded and/or removable, may include, for example, read-only memory, flash memory, magnetic storage devices (for example, hard disks, floppy disk drives, magnetic tape, etc.), optical disc drives and/or media, non-volatile random access memory (NVRAM), and/or the like. Like volatile memory 40 non-volatile memory 42 may include a cache area for temporary storage of data. The memories may store one or more software programs, instructions, pieces of information, data, and/or the like which may be used by the mobile terminal for performing functions of the mobile terminal. For example, the memories may comprise an identifier, such as an international mobile equipment identification (IMEI) code, capable of uniquely identifying the mobile terminal 10.

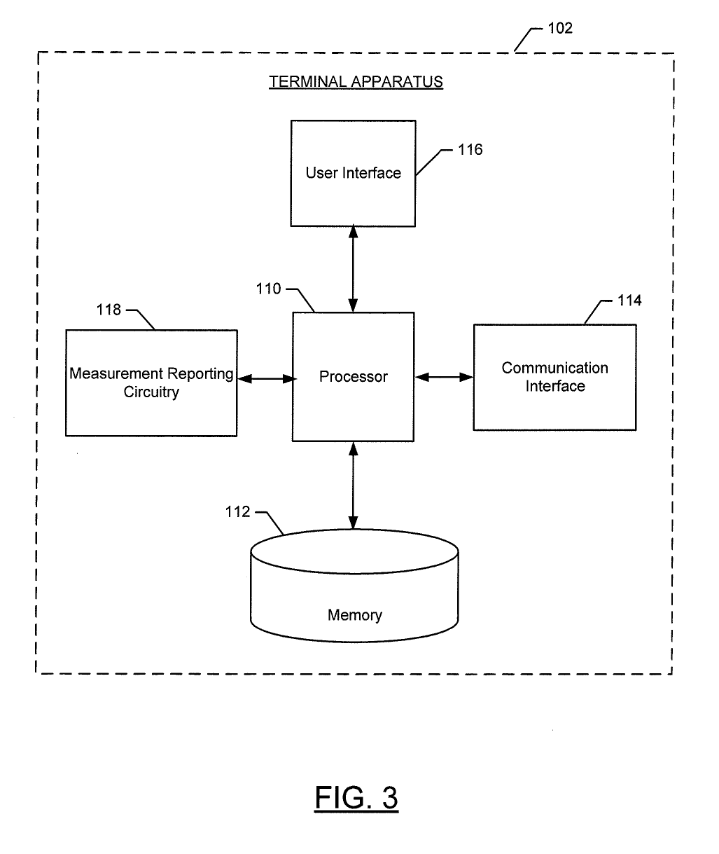

Referring now to FIG. 3, FIG. 3 illustrates a block diagram of a terminal apparatus 102 according to an example embodiment. In the example embodiment, the terminal apparatus 102 includes various means for performing the various functions herein described. These means may comprise one or more of a processor 110, memory 112, communication interface 114, user interface 116, or measurement reporting circuitry 118. The means of the terminal apparatus 102 as described herein may be embodied as, for example, circuitry, hardware elements (e.g., a suitably programmed processor, combinational logic circuit, and/or the like), a computer program product comprising computer-readable program instructions (e.g., software or firmware) stored on a computer-readable medium (for example memory 112) that is executable by a suitably configured processing device (e.g., the processor 110), or some combination thereof.

In some example embodiments, one or more of the means illustrated in FIG. 3 may be embodied as a chip or chip set. In other words, the terminal apparatus 102 may comprise one or more physical packages (for example, chips) including materials, components and/or wires on a structural assembly (for example, a baseboard). The structural assembly may provide physical strength, conservation of size, and/or limitation of electrical interaction for component circuitry included thereon. In this regard, the processor 110, memory 112, communication interface 114, user interface 116, and/or measurement reporting circuitry 118 may be embodied as a chip or chip set. The terminal apparatus 102 may therefore, in some example embodiments, be configured to implement embodiments of the present invention on a single chip or as a single “system on a chip.” As another example, in some example embodiments, the terminal apparatus 102 may comprise component(s) configured to implement embodiments of the present invention on a single chip or as a single “system on a chip.” As such, in some cases, a chip or chipset may constitute means for performing one or more operations for providing the functionalities described herein and/or for enabling user interface navigation with respect to the functionalities and/or services described herein.

The processor 110 may, for example, be embodied as various means including one or more microprocessors with accompanying digital signal processor(s), one or more processor(s) without an accompanying digital signal processor, one or more coprocessors, one or more multi-core processors, one or more controllers, processing circuitry, one or more computers, various other processing elements including integrated circuits such as, for example, an ASIC (application specific integrated circuit) or FPGA (field programmable gate array), or some combination thereof. Accordingly, although illustrated in FIG. 3 as a single processor, in some embodiments the processor 110 comprises a plurality of processors. The plurality of processors may be in operative communication with each other and may be collectively configured to perform one or more functionalities of the terminal apparatus 102 as described herein. The plurality of processors may be embodied on a single computing device or distributed across a plurality of computing devices collectively configured to function as the terminal apparatus 102. In embodiments wherein the terminal apparatus 102 is embodied as a mobile terminal 10, the processor 110 may be embodied as or comprise the processor 20. In some example embodiments, the processor 110 is configured to execute instructions stored in the memory 112 or otherwise accessible to the processor 110. These instructions, when executed by the processor 110, may cause the terminal apparatus 102 to perform one or more of the functionalities of the terminal apparatus 102 as described herein. As such, whether configured by hardware or software methods, or by a combination thereof, the processor 110 may comprise an entity capable of performing operations according to embodiments of the present invention while configured accordingly. Thus, for example, when the processor 110 is embodied as an ASIC, FPGA or the like, the processor 110 may comprise specifically configured hardware for conducting one or more operations described herein. Alternatively, as another example, when the processor 110 is embodied as an executor of instructions, such as may be stored in the memory 112, the instructions may specifically configure the processor 110 to perform one or more algorithms and operations described herein.

The memory 112 may comprise, for example, volatile memory, non-volatile memory, or some combination thereof. In this regard, the memory 112 may comprise one or more tangible and/or non-transitory computer-readable storage media that may include volatile and/or non-volatile memory. Although illustrated in FIG. 3 as a single memory, the memory 112 may comprise a plurality of memories. The plurality of memories may be embodied on a single computing device or may be distributed across a plurality of computing devices collectively configured to function as the terminal apparatus 102. In various example embodiments, the memory 112 may comprise a hard disk, random access memory, cache memory, flash memory, a compact disc read only memory (CD-ROM), digital versatile disc read only memory (DVD-ROM), an optical disc, circuitry configured to store information, or some combination thereof. In embodiments wherein the terminal apparatus 102 is embodied as a mobile terminal 10, the memory 112 may comprise the volatile memory 40 and/or the non-volatile memory 42. The memory 112 may be configured to store information, data, applications, instructions, or the like for enabling the terminal apparatus 102 to carry out various functions in accordance with various example embodiments. For example, in some example embodiments, the memory 112 is configured to buffer input data for processing by the processor 110. Additionally or alternatively, the memory 112 may be configured to store program instructions for execution by the processor 110. The memory 112 may store information in the form of static and/or dynamic information. This stored information may be stored and/or used by the measurement reporting circuitry 118 during the course of performing its functionalities.

The communication interface 114 may be embodied as any device or means embodied in circuitry, hardware, a computer program product comprising computer readable program instructions stored on a computer readable medium (for example, the memory 112) and executed by a processing device (for example, the processor 110), or a combination thereof that is configured to receive and/or transmit data from/to another computing device. In an example embodiment, the communication interface 114 is at least partially embodied as or otherwise controlled by the processor 110. In this regard, the communication interface 114 may be in communication with the processor 110, such as via a bus. The communication interface 114 may include, for example, an antenna, a transmitter, a receiver, a transceiver and/or supporting hardware or software for enabling communications with one or more remote computing devices. The communication interface 114 may be configured to receive and/or transmit data using any protocol that may be used for communications between computing devices. In this regard, the communication interface 114 may be configured to receive and/or transmit data using any protocol that may be used for transmission of data over a wireless network, wireline network, some combination thereof, or the like by which the terminal apparatus 102 and one or more computing devices or computing resources may be in communication. As an example, the communication interface 114 may be configured to enable communication between the terminal apparatus 102 and another device, such as another terminal apparatus 102. As a further example, the communication interface 114 may be configured to enable communication with a serving network apparatus 104 via the network 106. The communication interface 114 may additionally be in communication with the memory 112, user interface 116, and/or measurement reporting circuitry 118, such as via a bus.

The user interface 116 may be in communication with the processor 110 to receive an indication of a user input and/or to provide an audible, visual, mechanical, or other output to a user. As such, the user interface 116 may include, for example, a keyboard, a mouse, a joystick, a display, a touch screen display, a microphone, a speaker, and/or other input/output mechanisms. In embodiments wherein the user interface 116 comprises a touch screen display, the user interface 116 may additionally be configured to detect and/or receive indication of a touch gesture or other input to the touch screen display. The user interface 116 may be in communication with the memory 112, communication interface 114, and/or measurement reporting circuitry 118, such as via a bus.

The measurement reporting circuitry 118 may be embodied as various means, such as circuitry, hardware, a computer program product comprising computer readable program instructions stored on a computer readable medium (for example, the memory 112) and executed by a processing device (for example, the processor 110), or some combination thereof and, in some embodiments, is embodied as or otherwise controlled by the processor 110. In embodiments wherein the measurement reporting circuitry 118 is embodied separately from the processor 110, the measurement reporting circuitry 118 may be in communication with the processor 110. The measurement reporting circuitry 118 may further be in communication with one or more of the memory 112, communication interface 114, or user interface 116, such as via a bus.

In some example embodiments, the measurement reporting circuitry 118 may be configured to provide for connection with a network service according to a given network standard. For example, the measurement reporting circuitry 118 may be configured to provide for connection to a network service operating according to the LTE standard.

According to various embodiments, once connected to the network service, the measurement reporting circuitry 118 may be configured to receive measurement event configuration information. The measurement event configuration information may be received, for example, from a serving network apparatus 104 associated with the network service. In example embodiments, the measurement event configuration information may be received via a broadcast message, for example via a system information block (SIB). In other embodiments, the measurement event configuration information may be received via dedicated signaling, for example via an RRCConnectionReconfiguration message.

In certain embodiments, the measurement event configuration information may comprise data related to one or more events. The one or more events may be measurement reporting events. In some embodiments, the measurement reporting events may be events that identify when a terminal apparatus 102 should transmit a measurement report. For example, the events may correspond to one or more measurement reporting events specified according to a network standard, such as the E-UTRAN or LTE standard.

In various example embodiments, the measurement event configuration data may further comprise an indication of one or more cells or base stations. For example, the indication of one or more cells may comprise a Physical Cell Identity (PCI) list. In certain embodiments, the one or more cells may be indicated as a range of cells. For example, the range of cells may comprise a starting cell and an indication of the number of consecutive PCIs included in the range. In embodiments where the network is operating according to E-UTRAN, the range may be indicated by the PhysCellDRange information element.

According to various embodiments, the indication of one or more cells may identify to which cells the measurement event configuration applies. The indicated cells may comprise a subset of the available cells in the network. In some embodiments, the one or more cells may all be of the same type of cell (e.g. macrocells, microcells, picocells, femtocells, home cells, CSG cells, or the like). In other embodiments, the one or more cells may comprise a combination of cells of various types, for example the one or more cells may comprise the cells to which the terminal apparatus 102 associated with the measurement reporting circuitry 118 has access.

In other embodiments, the measurement event configuration information may be configured to specify one or more measurement identities (MeasIds) that are applicable to the one or more cells indicated. Each MeasId may be associated with a particular measurement object and reporting configuration, for example, via a MeasIdToAddModList in E-UTRAN. According to example embodiments, the MeasId may be further associated with the one or more cells indicated. In this regard, the measurement object and reporting configuration for the specified MeasId may also be associated with the one or more cells indicated. For example, in embodiments where the network is operating according to E-UTRAN, the MeasIdToAddModList information element may be configured to include an indication of one or more cells, such as via an additional PhysCellDRange information element.

In various example embodiments, the measurement reporting circuitry 118 may be configured to receive one or more instances of measurement event configuration information. The instances of measurement event configuration information may each comprise an indication of a distinct set of one or more cells to which the respective measurement event configuration information applies. Each cell from the distinct set of one or more cells may be selected from the group consisting of femtocells, microcells, home cells, closed subscriber group cells, picocells, and/or macrocells. For example, a first instance of measurement event configuration information may apply to a subset of cells comprising one or more femtocells, microcells, home cells, closed subscriber group cells, and/or picocells. A second instance of measurement event configuration information may apply to a subset of cells comprising macrocells.

In certain embodiments, each instance of measurement event configuration information may specify distinct event requirements for the one or more cells associated with the respective measurement event configuration information. For example, each instance of measurement event configuration information may comprise parameters corresponding to each of the one or more events that define how and/or when a report corresponding to that event will be triggered. The parameters may define different thresholds and/or offsets for a particular event based on the cells associated with the instance of measurement event configuration data. In this regard, the parameters may be configured such that a report related to an event corresponding to the first instance of measurement event configuration information may be triggered earlier than a report related to an event corresponding to the second instance of measurement event configuration information. In some embodiments, reports related to an event corresponding to the first instance of measurement event configuration information may be prioritized ahead reports related to an event corresponding to the second instance of measurement event configuration information.

According to various embodiments, the measurement reporting circuitry 118 may be further configured to detect an occurrence of an event defined by an instance of measurement event configuration information. The event may correspond to one or more measurement reporting events specified according to a network standard, such as the E-UTRAN or LTE standard, or, in some embodiments, the event may be a new event defined by the measurement event configuration information.

In example embodiments, the measurement reporting circuitry 118 may be further configured to determine the cell associated with the detected event. The measurement reporting circuitry 118 may further determine whether the cell associated with the detected event corresponds to a cell indicated by the measurement event configuration information corresponding to the event. In this regard, the measurement reporting circuitry 118 may determine which particular cell triggered the detected event. The measurement reporting circuitry 118 may then refer to the one or more cells indicated by the measurement event configuration information corresponding to the detected event. The measurement reporting circuitry 118 may then determine whether the cell that triggered the detected event corresponds to a cell indicated by the measurement event configuration information corresponding to the detected event. In some embodiments, if the measurement reporting circuitry 118 determines that the cell that triggered the detected event corresponds to a cell indicated by the measurement event configuration information corresponding to the detected event, the measurement reporting circuitry 118 may be configured to perform an action in response. In other embodiments, if the measurement reporting circuitry 118 determines that the cell that triggered the detected event does not correspond to a cell indicated by the measurement event configuration information corresponding to the detected event, the measurement reporting circuitry 118 may be configured to ignore the event and take no action in response.

According to various embodiments, in response to determining that the cell that triggered the detected event corresponds to a cell indicated by the measurement event configuration information corresponding to the detected event, the measurement reporting circuitry 118 may be configured to provide for transmission of a measurement report. The measurement reporting circuitry 118 may provide for transmission of a measurement report, for example, to a serving network apparatus 104. In some embodiments, the measurement report may comprise information specified for the particular event by the measurement event configuration information corresponding to the event.

In other embodiments, in response to determining that the cell that triggered the detected event does not correspond to a cell indicated by the measurement event configuration information corresponding to the detected event, the measurement reporting circuitry 118 may be configured not to provide for transmission of a measurement report. In this regard, the volume of measurement reports transmitted by the terminal apparatus 102 associated with the measurement reporting circuitry 118 may be reduced. For example, the particular events that trigger a measurement report to be transmitted may be limited to those events associated with cells indicated by the measurement event configuration information corresponding to the particular event. Therefore, in example embodiments, certain events may be considered valid for a particular group of cells and not all cells detectable by the measurement reporting circuitry 118. Such cell specific events may allow the measurement reporting circuitry 118 to send measurement reports in instances where the event detected correspond to a particular type of cell (e.g. macrocells, femtocells, picocell, home cells, CSG cells, or the like).

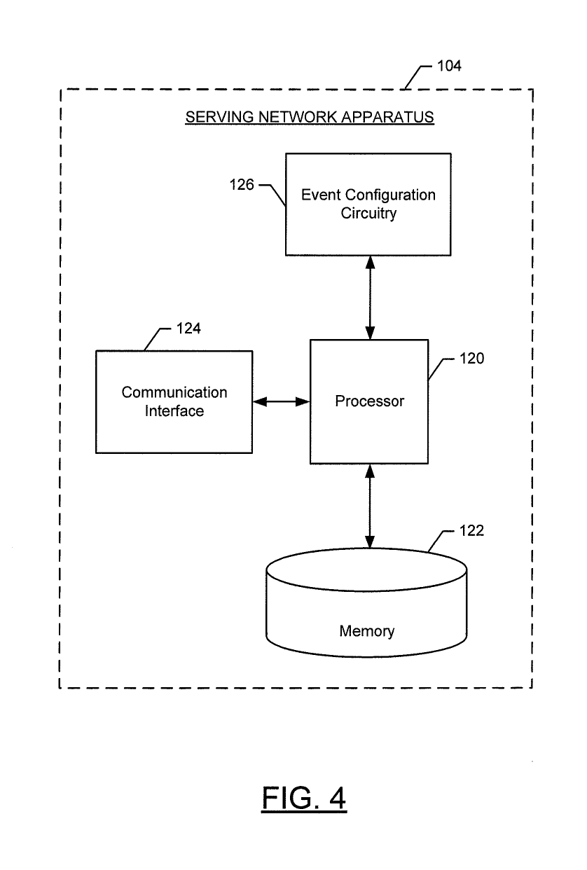

FIG. 4 illustrates a block diagram of a serving network apparatus 104 according to an example embodiment. In the example embodiment, the serving network apparatus 104 includes various means for performing the various functions herein described. These means may comprise one or more of a processor 120, memory 122, communication interface 124, or event configuration circuitry 126. The means of the serving network apparatus 104 as described herein may be embodied as, for example, circuitry, hardware elements (e.g., a suitably programmed processor, combinational logic circuit, and/or the like), a computer program product comprising computer-readable program instructions (e.g., software or firmware) stored on a computer-readable medium (e.g., memory 122) that is executable by a suitably configured processing device (e.g., the processor 120), or some combination thereof.

In some example embodiments, one or more of the means illustrated in FIG. 4 may be embodied as a chip or chip set. In other words, the serving network apparatus 104 may comprise one or more physical packages (for example, chips) including materials, components and/or wires on a structural assembly (for example, a baseboard). The structural assembly may provide physical strength, conservation of size, and/or limitation of electrical interaction for component circuitry included thereon. In this regard, the processor 120, memory 122, communication interface 124, and/or event configuration circuitry 126 may be embodied as a chip or chip set. The serving network apparatus 104 may therefore, in some example embodiments, be configured to implement embodiments of the present invention on a single chip or as a single “system on a chip.” As another example, in some example embodiments, the serving network apparatus 104 may comprise component(s) configured to implement embodiments of the present invention on a single chip or as a single “system on a chip.” As such, in some cases, a chip or chipset may constitute means for performing one or more operations for providing the functionalities described herein.

The processor 120 may, for example, be embodied as various means including one or more microprocessors with accompanying digital signal processor(s), one or more processor(s) without an accompanying digital signal processor, one or more coprocessors, one or more multi-core processors, one or more controllers, processing circuitry, one or more computers, various other processing elements including integrated circuits such as, for example, an ASIC (application specific integrated circuit) or FPGA (field programmable gate array), or some combination thereof. Accordingly, although illustrated in FIG. 4 as a single processor, in some embodiments the processor 120 comprises a plurality of processors. The plurality of processors may be in operative communication with each other and may be collectively configured to perform one or more functionalities of the serving network apparatus 104 as described herein. The plurality of processors may be embodied on a single computing device or distributed across a plurality of computing devices collectively configured to function as the serving network apparatus 104. In some example embodiments, the processor 120 is configured to execute instructions stored in the memory 122 or otherwise accessible to the processor 120. These instructions, when executed by the processor 120, may cause the serving network apparatus 104 to perform one or more of the functionalities of the serving network apparatus 104 as described herein. As such, whether configured by hardware or software methods, or by a combination thereof, the processor 120 may comprise an entity capable of performing operations according to embodiments of the present invention while configured accordingly. Thus, for example, when the processor 120 is embodied as an ASIC, FPGA or the like, the processor 120 may comprise specifically configured hardware for conducting one or more operations described herein. Alternatively, as another example, when the processor 120 is embodied as an executor of instructions, such as may be stored in the memory 122, the instructions may specifically configure the processor 120 to perform one or more algorithms and operations described herein.

The memory 122 may comprise, for example, volatile memory, non-volatile memory, or some combination thereof. In this regard, the memory 122 may comprise a non-transitory computer-readable storage medium. Although illustrated in FIG. 4 as a single memory, the memory 122 may comprise a plurality of memories. The plurality of memories may be embodied on a single computing device or may be distributed across a plurality of computing devices collectively configured to function as the serving network apparatus 104. In various example embodiments, the memory 122 may comprise a hard disk, random access memory, cache memory, flash memory, a compact disc read only memory (CD-ROM), digital versatile disc read only memory (DVD-ROM), an optical disc, circuitry configured to store information, or some combination thereof. The memory 122 may be configured to store information, data, applications, instructions, or the like for enabling the serving network apparatus 104 to carry out various functions in accordance with various example embodiments. For example, in some example embodiments, the memory 122 is configured to buffer input data for processing by the processor 120. Additionally or alternatively, the memory 122 may be configured to store program instructions for execution by the processor 120. The memory 122 may store information in the form of static and/or dynamic information. This stored information may be stored and/or used by the event configuration circuitry 126 during the course of performing its functionalities.

The communication interface 124 may be embodied as any device or means embodied in circuitry, hardware, a computer program product comprising computer readable program instructions stored on a computer readable medium (for example, the memory 122) and executed by a processing device (for example, the processor 120), or a combination thereof that is configured to receive and/or transmit data from/to another computing device. In an example embodiment, the communication interface 124 is at least partially embodied as or otherwise controlled by the processor 120. In this regard, the communication interface 124 may be in communication with the processor 120, such as via a bus. The communication interface 124 may include, for example, an antenna, a transmitter, a receiver, a transceiver and/or supporting hardware or software for enabling communications with one or more remote computing devices. The communication interface 124 may be configured to receive and/or transmit data using any protocol that may be used for communications between computing devices. In this regard, the communication interface 124 may be configured to receive and/or transmit data using any protocol that may be used for transmission of data over a wireless network, wireline network, some combination thereof, or the like by which the serving network apparatus 104 and one or more computing devices or computing resources may be in communication. As an example, the communication interface 124 may be configured to enable communication with a terminal apparatus 102 by the network 106, a radio uplink, and/or the like. The communication interface 124 may additionally be in communication with the memory 122, and/or event configuration circuitry 126, such as via a bus.

The event configuration circuitry 126 may be embodied as various means, such as circuitry, hardware, a computer program product comprising computer readable program instructions stored on a computer readable medium (for example, the memory 122) and executed by a processing device (for example, the processor 120), or some combination thereof and, in some embodiments, is embodied as or otherwise controlled by the processor 120. In embodiments wherein the event configuration circuitry 126 is embodied separately from the processor 120, the event configuration circuitry 126 may be in communication with the processor 120. The event configuration circuitry 126 may further be in communication with one or more of the memory 122 or communication interface 124, such as via a bus.

In some example embodiments, the event configuration circuitry 126 may be configured to provision a terminal apparatus 102 with network service according to a given network standard. For example, the event configuration circuitry 126 may be configured to operate according to the LTE standard.

According to various embodiments, the event configuration circuitry 126 may be configured to provide for transmission of measurement event configuration information. The measurement event configuration information may be transmitted, for example, to a terminal apparatus 102. In example embodiments, the measurement event configuration information may be transmitted via a broadcast message, for example via a system information block (SIB). In other embodiments, the measurement event configuration information may be transmitted via dedicated signaling. Further details related to the measurement event configuration information are provided above with respect to the description of the measurement reporting circuitry 118.

In some embodiments, the event configuration circuitry 126 may be configured to provide for transmission of one or more instances of measurement event configuration information. The instances of measurement event configuration information may each comprise an indication of a distinct set of one or more cells to which the respective measurement event configuration information applies. In this regard, the event configuration circuitry 126 may configure cell specific events. In some embodiments, a first instance of measurement event configuration information may associate a first group of cells with a first set of one or more events, and a second instance of measurement event configuration information may associate a second group of cells with a second set of one or more events. For example, one of the events of the first set of events may cause a terminal apparatus 102 to send a measurement report if the event is related to one of the cells of the first group of cells. If the event from the first set of events is not related to one of the cells from the first group of cells, the terminal apparatus may not be caused to send a measurement report. In certain embodiments, the first group of cells may be of a first type (e.g. femtocells) and the second group of cells may be of a second type (e.g. macrocells).

According to various embodiments, the event configuration circuitry 126 may be further configured to receive a measurement report. The measurement report may be sent by a terminal apparatus 102 in response to detecting an event specified by an instance of measurement event configuration information when the event is related to a cell indicated by the instance of measurement event configuration information. The event configuration circuitry 126 may be configured to use the information in the report to determine whether to initiate mobility procedures (e.g. handover).

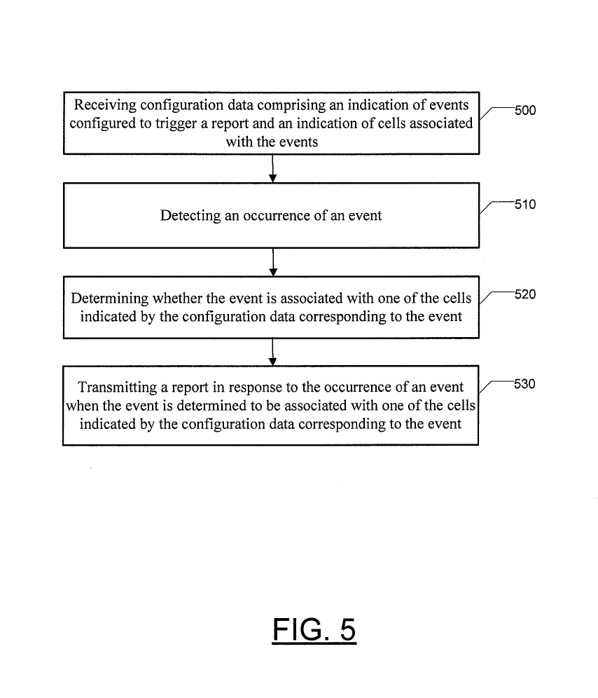

FIG. 5 illustrates a flowchart according to an example method for providing cell type specific measurement configuration according to an example embodiment. In this regard, FIG. 5 illustrates operations that may be performed at a terminal apparatus 102. The operations illustrated in and described with respect to FIG. 5 may, for example, be performed by, with the assistance of, and/or under the control of one or more of the processor 110, memory 112, communication interface 114, or measurement reporting circuitry 118. Operation 500 may comprise receiving configuration data comprising an indication of one or more events configured to trigger a report. The configuration data may comprise an indication of one or more cells associated with the one or more events. The processor 110, memory 112, communication interface 114, user interface 116, and/or measurement reporting circuitry 118 may, for example, provide means for performing operation 500. Operation 510 may comprise detecting an occurrence of one of the one or more events. The processor 110, memory 112, communication interface 114, user interface 116, and/or measurement reporting circuitry 118 may, for example, provide means for performing operation 510. Operation 520 may comprise determining whether the event is associated with at least one of the one or more cells indicated by the configuration data corresponding to the event. The processor 110, memory 112, communication interface 114, user interface 116, and/or measurement reporting circuitry 118 may, for example, provide means for performing operation 520. Operation 530 may comprise providing for transmission of a report when the event is determined to be associated with at least one of the one or more cells indicated by the configuration data corresponding to the event. The report may be provided for transmission in response to the occurrence of at least one of the one or more events associated with at least one of the one or more cells. The processor 110, memory 112, communication interface 114, user interface 116, and/or measurement reporting circuitry 118 may, for example, provide means for performing operation 530.

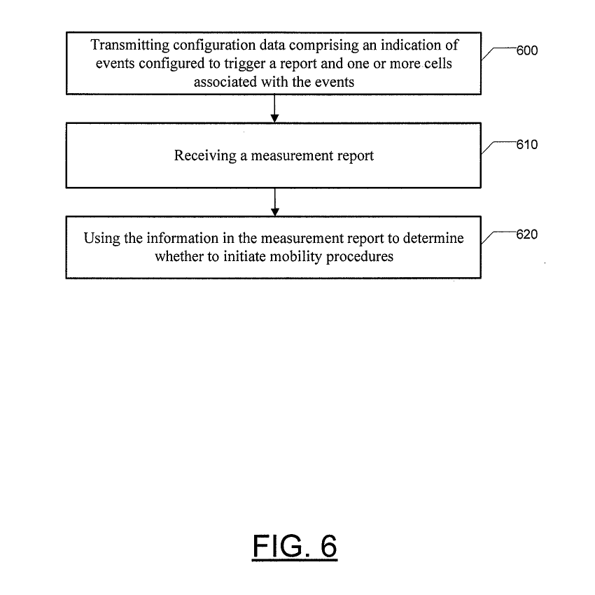

FIG. 6 illustrates a flowchart according to another example method for providing cell type specific measurement configuration according to an example embodiment. In this regard, FIG. 6 illustrates operations that may be performed at a serving network apparatus 104. The operations illustrated in and described with respect to FIG. 6 may, for example, be performed by, with the assistance of, and/or under the control of one or more of the processor 120, memory 122, communication interface 124, or event configuration circuitry 126. Operation 600 may comprise providing for transmission of configuration data comprising an indication of one or more events configured to trigger a report at a terminal apparatus 102. The configuration data may comprise an indication of one or more cells associated with the one or more events. The processor 120, memory 122, communication interface 124, and/or event configuration circuitry 126 may, for example, provide means for performing operation 600. Operation 610 may comprise receiving a measurement report from a terminal apparatus 102. The processor 120, memory 122, communication interface 124, and/or event configuration circuitry 126 may, for example, provide means for performing operation 610. Operation 620 may comprise using the information in the measurement report to determine whether to initiate mobility procedures. The processor 120, memory 122, communication interface 124, and/or event configuration circuitry 126 may, for example, provide means for performing operation 620.

FIGS. 5-6 each illustrate a flowchart of a system, method, and computer program product according to example embodiments of the invention. It will be understood that each block of the flowchart, and combinations of blocks in the flowchart, may be implemented by various means, such as hardware and/or a computer program product comprising one or more computer-readable mediums (as opposed to a computer-readable transmission medium which describes a propagating signal) having one or more computer program code instructions, program instructions, or executable computer-readable program code instructions stored therein. For example, one or more of the procedures described herein may be embodied by computer program instructions of a computer program product. In this regard, the computer program product(s) that embodies the procedures described herein may be stored by one or more memory devices (e.g., memory 122, volatile memory 40, or non-volatile memory 42) of a mobile terminal, server, or other computing device (e.g., the terminal apparatus 102) and executed by a processor (e.g., the processor 120 or processor 20) in the computing device. In some embodiments, the computer program instructions comprising the computer program product(s) that embodies the procedures described above may be stored by memory devices of a plurality of computing devices. As will be appreciated, any such computer program product may be loaded onto a computer or other programmable apparatus to produce a machine, such that the computer program product including the instructions which execute on the computer or other programmable apparatus creates means for implementing the functions specified in the flowchart block(s).

Further, the computer program product may comprise one or more computer-readable memories on which the computer program instructions may be stored such that the one or more computer-readable memories can direct a computer or other programmable apparatus to function in a particular manner, such that the computer program product comprises an article of manufacture which implements the function specified in the flowchart block(s). The computer program instructions of one or more computer program products may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flowchart block(s). Retrieval, loading, and execution of the program code instructions may be performed sequentially such that one instruction is retrieved, loaded, and executed at a time. In some example embodiments, retrieval, loading and/or execution may be performed in parallel such that multiple instructions are retrieved, loaded, and/or executed together.

Accordingly, execution of instructions associated with the operations of the flowchart by a processor, or storage of instructions associated with the blocks or operations of the flowchart in a computer-readable storage medium, support combinations of operations for performing the specified functions. It will also be understood that one or more operations of the flowchart, and combinations of blocks or operations in the flowchart, may be implemented by special purpose hardware-based computer systems and/or processors which perform the specified functions, or combinations of special purpose hardware and program code instructions.

The above described functions may be carried out in many ways. For example, any suitable means for carrying out each of the functions described above may be employed to carry out embodiments of the invention. In one embodiment, a suitably configured processor (for example, the processor 110 and/or processor 120) may provide all or a portion of the elements of the invention. In another embodiment, all or a portion of the elements of the invention may be configured by and operate under control of a computer program product. The computer program product for performing the methods of embodiments of the invention includes a computer-readable storage medium, such as the non-volatile storage medium (for example, the memory 112 and/or memory 122), and computer-readable program code portions, such as a series of computer instructions, embodied in the computer-readable storage medium.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions other than those explicitly described above are also contemplated as may be set forth in some of the appended claims. Although specific terms are employed herein, they are used in a generic and descriptive sense only and not for purposes of limitation.

1-36. (canceled)

37. A method comprising:
receiving configuration data comprising an indication of one or more events configured to trigger a report, wherein the configuration data comprises an indication of one or more cells associated with the one or more events;
providing for transmission of a report, wherein the report is provided for transmission in response to an occurrence of at least one of the one or more events associated with at least one of the one or more cells.

38. The method of claim 37, wherein receiving configuration data further comprises receiving a plurality of instances of configuration data, wherein each instance of configuration data comprises an indication of one or more events corresponding to a distinct group of one or more cells.

39. The method of claim 37, wherein each instance of configuration data comprises distinct parameters corresponding to the one or more events associated with the respective instance of configuration data, and wherein transmission of a report in response to an event corresponding to a first instance of configuration data is triggered differently than transmission of a report in response to an event corresponding to a second instance of configuration data based at least in part on the respective parameters.

40. The method of claim 37, wherein providing for transmission of a report corresponding to a first instance of configuration data is prioritized over providing for transmission of a report corresponding to a second instance of configuration data.

41. The method of claim 37, further comprising:
detecting an occurrence of one of the one or more events;
determining whether the event is associated with at least one of the one or more cells indicated by the configuration data corresponding to the event; and
providing for transmission of the report when the event is determined to be associated with at least one of the one or more cells indicated by the configuration data corresponding to the event.

42. An apparatus comprising:
at least one processor; and
at least one memory comprising computer program code, the at least one memory and the computer program code configured to, with the at least one processor, cause the apparatus at least to:
receive configuration data comprising an indication of one or more events configured to trigger a report, wherein the configuration data comprises an indication of one or more cells associated with the one or more events;
provide for transmission of a report, wherein the report is provided for transmission in response to an occurrence of at least one of the one or more events associated with at least one of the one or more cells.

43. The apparatus of claim 42, wherein in order to receive configuration data, the at least one memory and the computer program code are further configured to, with the at least one processor, cause the apparatus to:
receive a plurality of instances of configuration data, wherein each instance of configuration data comprises an indication of one or more events corresponding to a distinct group of one or more cells.

44. The apparatus of claim 42, wherein each of the one or more cells associated with an instance of configuration data is selected from the group consisting of femtocells, picocells, microcells, home cells, closed subscriber group cells, and macrocells.

45. The apparatus of claim 42, wherein each instance of configuration data comprises distinct parameters corresponding to the one or more events associated with the respective instance of configuration data, and wherein transmission of a report in response to an event corresponding to a first instance of configuration data is triggered differently than transmission of a report in response to an event corresponding to a second instance of configuration data based at least in part on the respective parameters.

46. The apparatus of claim 42, wherein providing for transmission of a report corresponding to a first instance of configuration data is prioritized over providing for transmission of a report corresponding to a second instance of configuration data.

47. The apparatus of claim 42, wherein the at least one memory and the computer program code are further configured to, with the at least one processor, cause the apparatus to:
detect an occurrence of one of the one or more events;
determine whether the event is associated with at least one of the one or more cells indicated by the configuration data corresponding to the event; and
provide for transmission of the report when the event is determined to be associated with at least one of the one or more cells indicated by the configuration data corresponding to the event.

48. A computer program product comprising a non-transitory computer-readable medium bearing computer program code embodied therein for use with a computer, the computer program code comprising:
code for receiving configuration data comprising an indication of one or more events configured to trigger a report, wherein the configuration data comprises an indication of one or more cells associated with the one or more events;
code for providing for transmission of a report, wherein the report is provided for transmission in response to an occurrence of at least one of the one or more events associated with at least one of the one or more cells.

49. A method comprising:
providing for transmission of configuration data comprising an indication of one or more events configured to trigger a report, wherein the configuration data comprises an indication of one or more cells associated with the one or more events;
receiving a measurement report; and
using the information in the measurement report to determine whether to initiate mobility procedures.

50. The method of claim 49, wherein each instance of configuration data comprises distinct parameters corresponding to the one or more events associated with the respective instance of configuration data, and wherein receiving a measurement report for an event corresponding to a first instance of configuration data is triggered differently than receiving a measurement report for an event corresponding to a second instance of configuration data based at least in part on the respective parameters.

51. The method of claim 49, wherein receiving a measurement report corresponding to a first instance of configuration data is prioritized over receiving a measurement report corresponding to a second instance of configuration data.

52. An apparatus comprising:
at least one processor; and
at least one memory comprising computer program code, the at least one memory and the computer program code configured to, with the at least one processor, cause the apparatus at least to:
provide for transmission of configuration data comprising an indication of one or more events configured to trigger a report, wherein the configuration data comprises an indication of one or more cells associated with the one or more events;
receive a measurement report; and
use the information in the measurement report to determine whether to initiate mobility procedures.

53. The apparatus of claim 52, wherein each of the one or more cells associated with an instance of configuration data is selected from the group consisting of femtocells, picocells, microcells, home cells, closed subscriber group cells, and macrocells.

54. The apparatus of claim 52, wherein each instance of configuration data comprises distinct parameters corresponding to the one or more events associated with the respective instance of configuration data, and wherein receiving a measurement report for an event corresponding to a first instance of configuration data is triggered differently than receiving a measurement report for an event corresponding to a second instance of configuration data based at least in part on the respective parameters.

55. The apparatus of claim 52, wherein receiving a measurement report corresponding to a first instance of configuration data is prioritized over receiving a measurement report corresponding to a second instance of configuration data.

56. A computer program product comprising a non-transitory computer-readable medium bearing computer program code embodied therein for use with a computer, the computer program code comprising:
code for providing for transmission of configuration data comprising an indication of one or more events configured to trigger a report, wherein the configuration data comprises an indication of one or more cells associated with the one or more events;
code for receiving a measurement report; and
code for using the information in the measurement report to determine whether to initiate mobility procedures.
